(19) United States
(12) Patent Application Publication
(10) Pub. No.: US 2012/0151999 A1
(43) Pub. Date: Jun. 21, 2012

(54) METHOD FOR ASCERTAINING A FLAP POSITION OF AN EXHAUST GAS HEAT EXCHANGER

(75) Inventors: Lothar SEYBOLD, Nauheim (DE); Kai-Ove PIETSCH, Weiterstadt (DE); Bert MOEHLMANN, Mainz (DE)

(73) Assignee: GM GLOBAL TECHNOLOGY OPERATIONS LLC, Detroit, MI (US)

(21) Appl. No.: 13/327,821

(22) Filed: Dec. 16, 2011

(30) Foreign Application Priority Data
Dec. 18, 2010 (DE) 10 2010 055 131.7

(51) Int. Cl. G01M 3/04; F01N 5/02

(52) U.S. Cl. 73/49.8; 60/272; 60/320

(57) ABSTRACT

A method is provided for ascertaining the setting of an exhaust gas flap, which is situated so it is adjustable in an exhaust system of a motor vehicle, by which a combustion gas flowing through an exhaust tract can alternately be supplied to a heat exchanger branch and/or a bypass branch, a pressure prevailing in the heat exchanger branch and/or in the bypass branch being measured to ascertain the setting of the exhaust gas flap, and a current position of the exhaust gas flap being ascertained by a comparison of the measured pressure to a reference value.

### CROSS-REFERENCE TO RELATED APPLICATION

This application claims priority to German Patent Application No. 102010055131.7, filed Dec. 18, 2010, which is incorporated herein by reference in its entirety.

### TECHNICAL FIELD

The technical field relates to a method for ascertaining the position of an exhaust gas flap, situated so it is adjustable in an exhaust system of a motor vehicle, in particular in connection with an exhaust gas heat exchanger. Furthermore, the invention relates to an exhaust system that is to implement the method.

### BACKGROUND

Exhaust gas heat exchangers are used to reclaim energy from a hot exhaust gas stream, to accelerate the warming up of an internal combustion engine to its operating temperature during a starting or cold starting phase, for example. The exhaust gas heat exchanger is coupled to the cooling circuit of the internal combustion engine, for example. The application of hot exhaust gas to the exhaust gas heat exchanger is preferably regulated using an exhaust gas flap, which completely or partially supplies the exhaust gas stream to the exhaust gas heat exchanger, inter alia, as a function of the temperature of a heat exchanger medium and/or in consideration of an applied engine load.

For this purpose, the exhaust tract has a branching structure having a heat exchanger branch and a bypass branch, the exhaust gas stream alternately able to conduct via the bypass branch and/or via the heat exchanger branch via the exhaust gas flap, which is situated so it is adjustable in the exhaust tract. Depending on the setting of the exhaust gas flap and the accompanying flow and pressure conditions in the exhaust tract, the exhaust gas counter pressure of the exhaust system can vary accordingly.

Such pressure changes can particularly have an effect on the mixture formation of the combustion processes occurring in the upstream internal combustion engine. As a result, the exhaust gas composition can vary and, under certain circumstances, provided emission values can even be exceeded for a short time. For example, an exhaust system for an internal combustion engine and an associated operating method are described in DE 10 2008 023 806 A1, at least one controllable switching element for guiding the exhaust gas stream being provided in an exhaust duct. A control unit is provided for activating the switching element, whose activation is performed as a function of the temperature of means for converting thermal energy and/or as a function of an exhaust gas counter pressure prevailing in the exhaust system and/or as a function of the temperature of the internal combustion engine.

Since the exhaust gas flap is preferably actuated using a thermostat, i.e., solely dependent on temperature and solely mechanically, and cannot be influenced by onboard electronics, no analyzable information with respect to the actual position of the exhaust gas flap is available to the onboard electronics of the motor vehicle. The arrangement of an electrically based rotational angle sensor or position sensor does not come into consideration because of the prevailing heat development in the exhaust tract.

It is therefore at least one object to provide a method and an exhaust system, which allow an ascertainment of the actual position of an exhaust gas flap. The flap setting is to be implementable as simply, robustly, low-maintenance, and cost-effectively as possible. Furthermore, the current and actual position or setting of the exhaust gas flap is to be able to be ascertained with a precision sufficient for the purposes of engine control. In addition, other objects, desirable features, and characteristics will become apparent from the subsequent summary and detailed description, and the appended claims, taken in conjunction with the accompanying drawings and this background.

### SUMMARY

The object on which the invention is based is achieved by a method for ascertaining the setting of an exhaust gas flap and by an exhaust tract, and a motor vehicle. The method is provided for ascertaining the setting of an exhaust gas flap situated so it is adjustable in an exhaust system of a motor vehicle, which is implemented for supplying a combustion gas flowing through an exhaust tract alternately to a heat exchanger branch and/or a bypass branch of the exhaust system. The exhaust gas flap can supply the combustion gas in this case completely to either the bypass branch or the heat exchanger branch or can also allocate an exhaust gas stream in varying ratios to the two branches, depending on the flap setting.

A varying exhaust gas counter pressure can result in the exhaust system in accordance with the position of the exhaust gas flap, which can influence the mixture formation of the combustion process in the upstream internal combustion engine. To ascertain the actual position of the exhaust gas flap, it is if a pressure prevailing in the heat exchanger branch and/or in the bypass branch is measured and the setting or configuration of the exhaust gas flap is ascertained by a comparison of the measured pressure to at least one reference value.

The pressure measurement is preferably performed using at least one pressure sensor, which is coupled in a hydrostatic or hydrodynamic manner via a separate pressure-transmitting connecting line to the corresponding branch of the exhaust tract, for example, but is situated spaced apart therefrom on the motor vehicle or on its exhaust system. In this manner, the pressure sensor or sensors can be situated protected from the extreme heat development of the exhaust system. By measuring at least one pressure in one of the two branches of the exhaust system and by comparing the measured pressure to a reference value, sufficiently precise conclusions about the exhaust gas flap setting can be drawn, so that an activation of the internal combustion engine, in particular the control of the combustion procedure, can be regulated in consideration of the respective prevailing exhaust gas flap setting.

It is provided that the reference value is ascertained by measuring the pressure in the bypass branch and/or in the heat exchanger branch and/or in the exhaust tract located upstream from the exhaust gas flap. Furthermore, it is conceivable to also ascertain the reference value in a section of the exhaust tract located downstream from the bypass branch and/or the heat exchanger branch. The current flap setting can also be derived directly from a comparison of the exhaust gas pressures measured in the bypass branch and in the heat exchanger branch.

Furthermore, the flap setting can be ascertained in consideration of three or more pressures measured at a specific time in greatly varying areas of the exhaust system, thus, for example, in a section upstream from the exhaust gas flap, in the bypass branch, in the heat exchanger branch, and/or in a section of the exhaust tract downstream from the two branches. Independently of the number of measured pressure values, which are accordingly to be analyzed, the flap setting can be calculated, for example, in each case as a function of a functional relationship between the individual pressures and the flap setting or also can be determined or interpolated by comparison with an empirically ascertained characteristic diagram.

Furthermore, it is conceivable in the case that the reference value is determined, for example, from the speed of the internal combustion engine feeding the exhaust tract and/or as a function of its engine load, preferably therefrom. The speed and the engine load are typically a measure of the mass flow rate prevailing in the exhaust tract. If the engine speed or the engine load is significantly above an idle speed or “zero load”, for example, it is to be presumed that a noteworthy mass flow rate is flowing through the exhaust tract. If the pressure measured in the bypass branch has risen hardly or not at all in such a case, it is presumed that the exhaust gas flap is conducting the exhaust gas stream nearly entirely via the heat exchanger branch.

It is further provided that the reference value is read out from a characteristic diagram stored in a control unit. The characteristic diagram can be stored, for example, as a pressure-speed diagram in the control unit. Thus, in particular a plurality of such characteristic diagrams can be stored as a function of temperature, and to determine a flap setting, in each case the characteristic diagram corresponding to a prevailing temperature can be used to determine the exhaust gas flap setting.

Furthermore, a hydrostatic and/or hydrodynamic pressure is measured in the exhaust tract, in the heat exchanger branch, and/or in the bypass branch. Corresponding pressure sensors designed to measure static or hydrodynamic pressures can be coupled in a suitable manner to the respective branch or to provide sections of the exhaust tract to ascertain the respective pressure conditions prevailing therein.

Furthermore, the angle setting or position or configuration and orientation of the exhaust gas flap, which is ascertained based on the measured pressure, is used to optimize the combustion procedure of the internal combustion engine, and is supplied to a control unit of an internal combustion engine for this purpose. It is conceivable in particular in this case that the at least one pressure sensor is directly coupled to the control unit, and the ascertainment of the flap setting is performed directly in the control unit. The optimization of the combustion procedure either can be individually calculated according to known causal relationships or can be performed according to an empirically ascertained control curve, which regulates a mixture formation as a function of the flap setting or the exhaust gas counter pressure of the exhaust system, for example.

In an embodiment, it is further provided that in the case of an ascertained exhaust gas flap setting which deviates from a target value range, a warning signal is generated and/or the control unit automatically changes an activation of the internal combustion engine, in order to keep the exhaust gas composition or the emission values of the internal combustion engine in a predefined range, for example. Furthermore, it is conceivable that the at least one reference value and the at least one measured pressure are checked for plausibility, in particular in consideration of further parameters relevant to the exhaust gas, such as the engine speed or the engine load. If a measured pressure value cannot be brought into correspondence with the reference value or with other engine-specific parameters, for example, a warning signal that is visually or acoustically perceptible to the driver is generated, which is output so it is recognizable to the driver of the vehicle.

According to an embodiment, it is further provided that the setting of the exhaust gas flap is ascertained in consideration of an exhaust gas counter pressure-engine speed characteristic diagram. In such a characteristic diagram, for example, the exhaust gas counter pressure that normally prevails in the bypass branch or in the heat exchanger branch can be stored as a function of an engine speed and/or an engine load. Such characteristic diagrams may further be empirically ascertained for different flap settings and subjected to further calibration or calculation, so that clear conclusions about the respective prevailing flap setting can be drawn on the basis of the engine speed and/or the engine load and at least one measured pressure value.

According to a further embodiment, the setting of the exhaust gas flap is further ascertained in consideration of a temperature prevailing in the exhaust tract, temperature-specific characteristic diagrams being stored in the control unit and/or existing characteristic diagrams being calibrated by a temperature coefficient. It can also be provided in this case that a temperature measurement is performed on or in the exhaust tract as a supplement to the pressure measurement and the measured temperature is considered to ascertain the flap setting.

In a concurrent aspect, which is independent thereof, an exhaust system of an internal combustion engine of a motor vehicle is additionally provided, which has at least one exhaust tract having a heat exchanger branch and a bypass branch, in which at least one adjustable exhaust gas flap is situated. The combustion gas flowing through the exhaust tract can be supplied alternately to the heat exchanger branch and/or the bypass branch by means of the exhaust gas flap. In this case, at least one pressure sensor is coupled to the heat exchanger branch and/or to the bypass branch to ascertain at least one pressure therein in each case. The at least one pressure sensor is further connected to a control unit, which is implemented for the purpose of ascertaining the current setting of the exhaust gas flap by comparison of the measured pressure to at least one reference value.

The ascertainment or determination of the exhaust gas flap setting is performed in this case according to the above-described method, further pressures, which are measured in the bypass branch and/or in the heat exchanger branch or in an area upstream from the exhaust gas flap, for example, and also further parameters specific to the internal combustion engine, such as the speed or the temperature in the exhaust tract, being able to be used as reference values. Furthermore, at least one pressure sensor is assigned in each case to the heat exchanger branch and also the bypass branch, in such a manner that an angle setting or a position of the exhaust gas flap can be derived or ascertained by comparison of the pressures ascertained by the pressure sensors. Optionally, still further pressure sensors can be used, in particular in a section of the exhaust tract upstream from the exhaust gas flap. The pressure sensors can be variably implemented as hydrostatic or hydrodynamic sensors, and as passive, relative, absolute, or differential pressure sensors.

Furthermore, the control unit can use stored and preferably empirically ascertained characteristic diagrams to assign the at least one measured pressure, optionally with further consideration of the respective prevailing engine speed and/or engine load, to a specific flap setting or position. Furthermore, it is provided for the exhaust system that the at least one pressure sensor is coupled via a pressure-transmitting connection to the exhaust tract, to the heat exchanger branch, and/or to the bypass branch, and is situated in each case spaced apart from the exhaust tract or its two branches, heat exchanger branch and/or exhaust gas branch.

According to a further embodiment, a motor vehicle is also provided, which has an above-described exhaust system having an exhaust gas heat exchanger.

### BRIEF DESCRIPTION OF THE FIGURES

The present invention will hereinafter be described in conjunction with the following drawing figures, wherein like numerals denote like elements, and:

FIG. 1 shows a schematic view of a branching exhaust tract, which is provided with an exhaust gas heat exchanger, having an exhaust gas flap in the bypass setting;

FIG. 2 shows the exhaust system according to FIG. 1 having the exhaust gas flap in the heat exchanger setting;

FIG. 3 shows a further embodiment of an exhaust system having an exhaust gas flap located in the bypass setting;

FIG. 4 shows the exhaust system according to FIG. 3 having an exhaust gas flap located in the heat exchanger setting; and

FIG. 5 shows a schematic view of an exhaust gas counter pressure-engine speed characteristic diagram.

### DETAILED DESCRIPTION

The following detailed description is merely exemplary in nature and is not intended to limit application and uses. Furthermore, there is no intention to be bound by any theory presented in the preceding background or summary of the invention or the following detailed description.

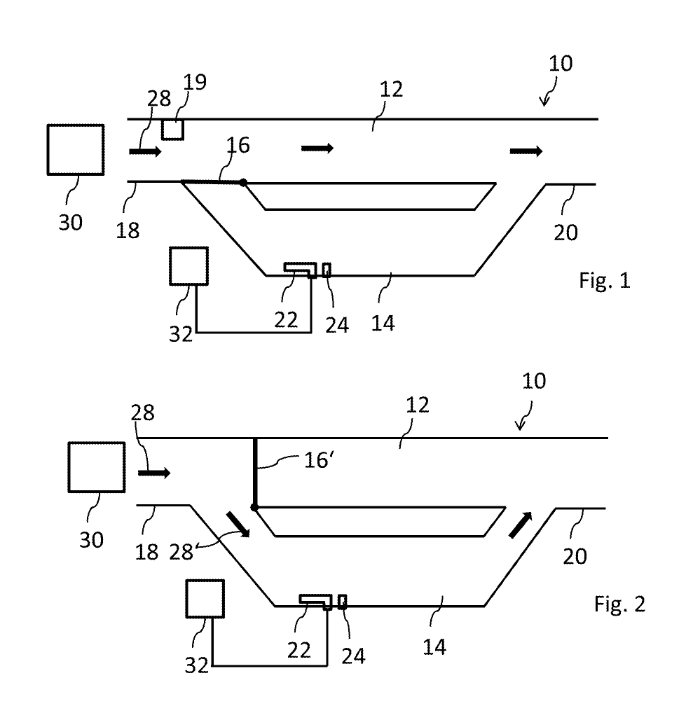

The exhaust system 10, which is schematically shown in FIG. 1 and FIG. 2, has an exhaust tract 18, which is fed by an internal combustion engine 30, and which forks into a bypass branch 12 and a heat exchanger branch 14 and subsequently is unified again in an area 20 located downstream from the two branches 12, 14. An adjustably situated exhaust gas flap 16 is provided in the area of the branch, which is mounted in the present exemplary embodiments so it is pivotable between the settings shown in FIG. 1 and FIG. 2.

Depending on the setting of the exhaust gas flap 16, the exhaust gas stream 28 generated by the engine 30 can flow either completely, as shown in FIG. 1, via the bypass branch 12 or, as shown in FIG. 2, completely via the heat exchanger branch 14. In particular, in the case of an entirely possible intermediate position (not shown here) of the exhaust gas flap 16, the exhaust gas stream 28 can be allocated in equal or unequal components to the bypass branch 12 and the heat exchanger branch 14.

The flow and pressure conditions in the exhaust system 10 change in accordance with the respective setting of the exhaust gas flap 16, 16′. The exhaust gas counter pressure provided by the exhaust system 10 can thus be subject to certain changes, which can have an effect on the mixture formation of the combustion process of the internal combustion engine 30. To maintain predefined emission values, it is necessary to provide the setting of the exhaust gas flap 16 to an onboard diagnostic system of the motor vehicle. Since the exhaust gas flap 16 is preferably actuated solely thermally, for example, by means of a thermostat situated on the exhaust gas heat exchanger, and therefore an active activation of the flap 16 by an electrical control unit of the motor vehicle, for example, is not provided, the flap setting must be ascertained separately for diagnostic purposes.

In the embodiment according to FIG. 1 and FIG. 2, pressure sensors 22, 24 are assigned to the heat exchanger branch 14 to determine the flap setting. The pressure sensors 22, 24 themselves are situated sufficiently spaced apart, via a pressure-transmitting line, from the exhaust-conducting pipe or duct of the exhaust system 10, so as not to impair their functional capability by heat action of the exhaust system 10. For example, the pressure sensor 22 can be implemented as a hydrodynamic sensor for measuring a flow pressure and the pressure sensor 24 can be implemented as a static pressure sensor for measuring the hydrostatic pressure. The bypass branch 12 is implemented as substantially free of pressure sensors in this case. A pressure measurement is only performed in the heat exchanger branch 14 in the embodiment shown in FIG. 1 and FIG. 2. A pressure loss via the heat exchanger branch 14 can be ascertained by means of the pressure sensors 22, 24 and the measured hydrostatic and/or hydrodynamic pressures can be compared to reference values, to be able to draw clear conclusions about the setting of the flap 16 therefrom.

Furthermore, for example, a temperature sensor 19, which is used to ascertain the exhaust gas temperature, can also be provided in the exhaust tract 18 upstream from the exhaust gas flap 16 or also at another position. An active measurement of the temperature of the coolant flowing through the heat exchanger branch 14 can also be performed, but this is not explicitly shown in the figures. Furthermore, the engine speed, the engine load, the temperature of the exhaust system, and further parameters operationally relevant for the engine can be used as reference or comparison values. In the configuration having closed exhaust gas flap shown in FIG. 1, the combustion gas 28′ flows substantially completely through the bypass branch 12. A change of the engine speed or the engine load, which accompanies a corresponding change of the volume stream of the combustion gas 28′, has no noteworthy effects in this case on the pressure measurement permanently occurring in the heat exchanger branch 14. The control unit 32 coupled to the pressure sensors 22, 24 can thus ascertain a closed setting of the exhaust gas flap 16.

In the case of an open setting of the exhaust gas flap 16′ shown in FIG. 2, however, this situation is represented differently. The combustion gas 28′ flows completely through the heat exchanger branch 14. A change of the engine speed and/or the engine load has direct effects on the pressure conditions measurable in the heat exchanger branch 14 in this case. By comparing the pressure measured values to a characteristic curve, optionally in consideration of prevailing temperatures of the exhaust tract and/or the refrigerant circulating in the heat exchanger, the angle setting of the flap 16′ can be ascertained very precisely, for example.

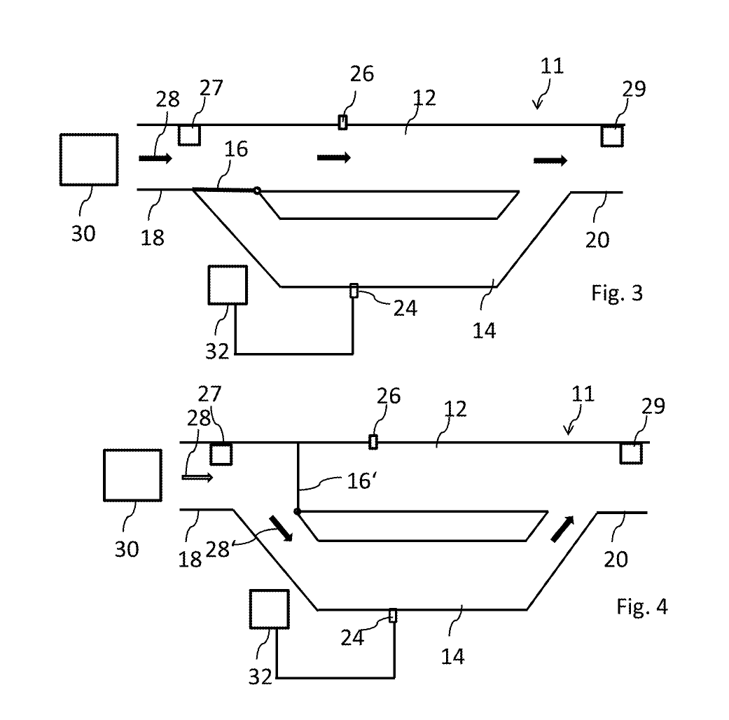

The embodiment of a further exhaust system 11 shown in FIG. 3 and FIG. 4 differs solely through the arrangement of multiple pressure sensors 24, 26, 27, 29, which are situated spatially distributed, from the embodiment shown in FIG. 1 and FIG. 2. One pressure sensor 26, 24 is situated in each of the two branches 12, 14 of the exhaust system 11 here. Optionally, a further hydrostatic or hydrodynamic pressure sensor 27 can be provided in a section of the exhaust tract 18 upstream from the exhaust gas flap 16. In a corresponding manner, a pressure measurement by means of a further pressure sensor 29 can also be performed in an area downstream from the branching structure formed by bypass and heat exchanger branches 12, 14. A direct comparison of the measuring signals delivered by the parallel pressure sensors 24, 26 situated in branches can already detect an open or closed setting of the exhaust gas flap 16. Furthermore, conclusions about the angle setting of the exhaust gas flap 16 between the end positions shown in FIG. 3 and FIG. 4 can be ascertained with further consideration of the total pressure present in the exhaust system 11, which is ascertained using the upstream sensor 27.

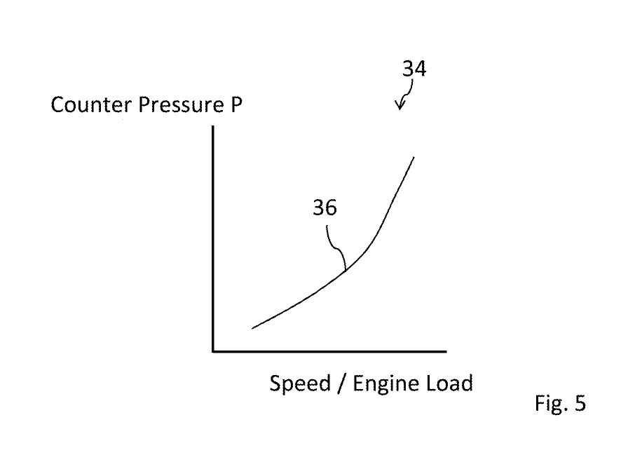

Finally, FIG. 5 shows a schematic exhaust gas counter pressure-speed characteristic diagram 34. The exhaust gas counter pressure is plotted against an engine speed and/or against an engine load by means of a graph 36 in the characteristic diagram 34. The exhaust gas counter pressure in the exhaust system 10, 11 increases with increasing engine speed and/or engine load. A plurality of such characteristic diagrams 34 can be empirically ascertained for at least one of the branches, bypass branch 12 and/or heat exchanger branch 14, for a plurality of different settings of the exhaust gas flap 16 and stored in a memory accessible by the control unit 32 and processed in such a manner that clear conclusions about the current setting of the exhaust gas flap 16 can be drawn on the basis of at least one measured pressure and a further system parameter, such as a further pressure or an engine speed or an engine load.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A method for ascertaining a setting of an exhaust gas flap situated for adjustability in an exhaust system of a motor vehicle,
measuring a pressure prevailing in a branch
comparing the pressure to a reference; and
ascertaining the setting of the exhaust gas flap and a current position of the exhaust gas flap from the comparing the pressure to the reference.

2. The method according to claim 1, wherein the branch is a heat exchanger branch.

3. The method according to claim 1, wherein the branch is a bypass branch.

4. The method according to claim 1, further comprising determining the reference from a speed of an internal combustion engine that feeds an exhaust tract.

5. The method according to claim 1, further comprising determining the reference from a load of an internal combustion engine that feeds an exhaust tract.

6. The method according to claim 1, further comprising accessing the reference from a characteristic diagram stored in a control unit.

7. The method according to claim 1, further comprising measuring a hydrostatic pressure in the branch.

8. The method according to claim 1, further comprising measuring a hydrodynamic pressure in the branch.

9. The method according to claim 1, further comprising:
ascertaining an angle of the exhaust gas flap on a basis of the pressure; and
optimizing a combustion procedure of an internal combustion engine based at least partially on the angle.

10. The method according to claim 1, further comprising generating a warning signal in event of a deviation of the exhaust gas flap setting from a target value range.

11. The method according to claim 1, further comprising a control unit automatically changing an activation of an internal combustion engine in event of a deviation of the exhaust gas flap setting from a target value range.

12. The method according to claim 1, wherein the setting of the exhaust gas flap is ascertained in consideration of an exhaust gas counter pressure-engine speed characteristic diagram.

13. The method according to claim 1, wherein the setting of the exhaust gas flap is ascertained in consideration of a temperature prevailing in an exhaust tract.

14. An exhaust system of an internal combustion engine of a motor vehicle, comprising:
an exhaust tract having a branch;
an adjustable exhaust gas flap by which a combustion gas flowing through the exhaust tract is supplied to the branch;
a pressure sensor coupled to the branch and configured to ascertain a pressure prevailing therein;
a control unit coupled to the pressure sensor, the control unit configured to ascertain a current setting of the adjustable exhaust gas flap by comparing the pressure to a reference.

15. The exhaust system according to claim 14, further comprising a second pressure sensor assigned to a heat exchanger branch and, and an angle setting of the adjustable exhaust gas flap is be ascertained by comparing the pressure ascertained by the pressure sensor,
wherein the branch is a bypass branch.

16. The exhaust system according to claim 14, wherein a further pressure sensor is coupled to a section of the exhaust tract located upstream from the adjustable exhaust gas flap.

17. The exhaust system according to claim 14, wherein the pressure sensor is coupled with a pressure-transmitting connection to the exhaust tract and situated spaced apart from the exhaust tract.

18. The exhaust system according to claim 14, wherein the branch is a heat exchanger branch.

19. The exhaust system according to claim 14, wherein the branch is a bypass branch.
